(19) United States
(12) Patent Application Publication
(10) Pub. No.: US 2016/0063464 A1
(43) Pub. Date: Mar. 3, 2016

(54) METHOD OF PROVIDING WEB CONTENT TO CONSUMERS

(71) Applicant: Dapo APARA, Lagos (NG)

(72) Inventor: Dapo APARA, Lagos (NG)

(21) Appl. No.: 14/470,196

(22) Filed: Aug. 27, 2014

(51) Int. Cl. G06Q 20/12; G06Q 30/06

(52) U.S. Cl. CPC G06Q 20/123; G06Q 30/0633

(57) ABSTRACT

A method of distributing web content includes providing a website accessible to web content providers and consumers. The method further includes registering at least one content provider. The method further includes querying the at least one content provider for content. The method further includes querying the at least one content provider for a desired fee for the content. The method further includes registering a consumer via software executing on a computer. The method further includes displaying a representation of the content and the fee to the consumer on the website via software executing on a computer. The method further includes providing the content to the consumer in response to a request from the consumer. The method further includes collecting the fee from the consumer via software executing on a computer. The method further includes providing a portion of the fee to the content provider that provided the content.

### BACKGROUND

Currently, web content providers pay aggregators such as search engines (e.g. Google) for clicks and views of their content. This means content providers who cannot make this payment are denied high volume traffic to their content through these aggregators. As a result, the internet is not as rich in variety as it could be.

Many potential content providers are not encouraged to provide content, while some providers who do provide web content go out of business because they are unable to earn enough from their content to sustain their business because of advertising costs. Content consumers are also not encouraged to consume as much premium content as they desire, as this will entail registering on a large number of sites of the content providers.

In one current content delivery model, the user registers on each individual website for the content of that provider. However this model is highly inconvenient as the user is forced to register on a large number of sites. Moreover, this model creates fragmentation, so it cannot scale.

There remains a need in the art for a way to link consumers with web content with lower barriers to entry and transaction costs.

### BRIEF SUMMARY

A method of distributing web content includes providing a website accessible to web content providers and consumers. The method further includes registering at least one content provider via software executing on a computer. The method further includes querying the at least one content provider for content via software executing on a computer. The method further includes querying the at least one content provider for a desired fee for the content via software executing on a computer. The method further includes registering a consumer via software executing on a computer. The method further includes displaying a representation of the content and the fee to the consumer on the website via software executing on a computer. The method further includes providing the content to the consumer in response to a request from the consumer. The method further includes collecting the fee from the consumer via software executing on a computer. The method further includes providing a portion of the fee to the content provider that provided the content.

In some embodiments, providing a portion of the fee to the content provider that provided the content is performed via software executing on a computer. In some embodiments, the method further includes querying the consumer for feedback on the content. In some embodiments, the method further includes providing a portion of the fee collected to the provider of the website. In some embodiments, the method further includes collecting payment information from the consumer via software executing on a computer. In some embodiments, the method further includes collecting account information from the at least one content provider. In some embodiments, the fee is collected on a per-click basis. In some embodiments, the fee is collected on a periodical basis. In some embodiments, the method further includes penalizing a content provider if their content is unavailable. In some embodiments, the method further includes collecting a deposit from the consumer prior to providing content to them.

### BRIEF DESCRIPTION OF THE DRAWINGS

FIG. 1 is a flowchart of the method according to one embodiment.

### DETAILED DESCRIPTION

According to the method described herein, the user registers with a single aggregator, and thereby has access to a variety of content by a large number of content providers. More content providers can be added with time. The method described herein provides a scalable model for both content providers and content consumers. The more content consumers and content providers there are, the more the economies of scale—leading to lower subscription cost to consumers, and more profitable returns to content providers. This method will lead to more content providers providing their content online.

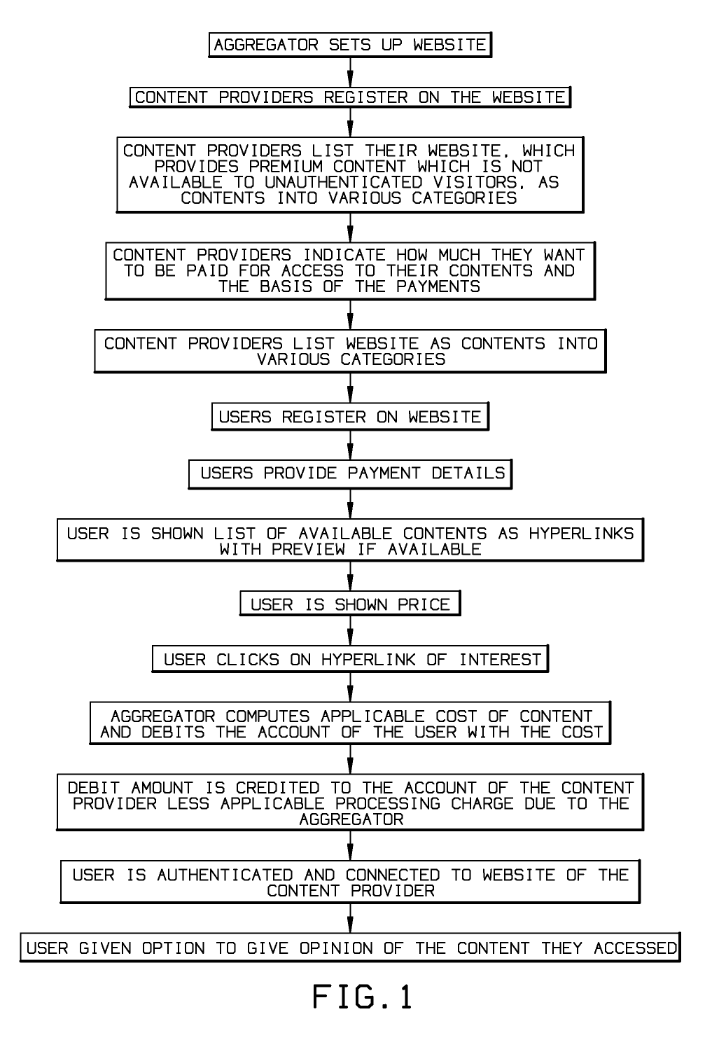

According to the embodiment shown in FIG. 1, the method includes:
1. The aggregator sets up a website.
2. The content providers register with the website.
3. The content providers list their website, which provides premium content which is not available to unauthenticated visitors, and places contents into various categories.
4. The content providers indicate how much they want to be paid for access to their content and the basis of the payments.
5. Users register on the website.
6. Users provide payment details.
7. The user is shown a list of available contents as hyperlinks with previews where available.
8. The user is shown a price.
9. The user clicks on a hyperlink of interest.
10. The aggregator computes applicable cost of content and debits the account of the user in the amount of the cost.
11. The debit amount is credited to the account of the content provider—less applicable processing fees for the aggregator.
12. The user is authenticated and connected to the website of the content provider.
13. The user is given option to give opinion or feedback of the content they accessed.
   In one embodiment, the method includes:
1. User registers on the aggregators website.
2. User is shown a list of content providers and the type of contents provided by each provider, e.g. news, games, etc. . . . .
3. The content providers indicate how they want to be paid for their contents, e.g. per click or per view and how much and the frequency daily, weekly, monthly etc. . . . .
4. Content providers and/or their contents are categorized.
5. User can choose from as many categories as he/she desires.
6. Based on the user's choices a deposit is calculated and deducted from the user's credit card or mode of payment.
7. User then access the contents as desired, and the system monitors the content accessed and the frequency of access.
8. Based on the user's usage, a periodic charge is computed and deducted from his/her deposit.
9. The amount deducted is applied to the credit of the content providers based on pre-agreed formula less a processing fee for the aggregator.

### How to Implement the Method:

1. Set up a website or a communication system which can be accessed directly/indirectly by content providers.
2. Set up a website or communication system which can be accessed by users.
3. Item 1 and 2, above can be the same system or different systems.
4. Review the websites and content of the content providers to enable proper classification.
5. Ensure guarantee of uptime and accessibility by content providers, and a system to penalize content providers when their content is unexpectedly unavailable.
6. Ensure a system of credit review of content users, e.g. by requiring a large enough prepaid deposit.
7. Ensure a system of content rating and review by users.
8. Setup a user login validation system which allows a user to be validated to the aggregator before allowing or denying access to the desired content.
9. Calculate the charge to the user based on the pricing model, e.g. if pricing is per click, then the user is charged for each access to the site irrespective of how long. If model is based on views then user is charged based on how long he/she remains logged in to the content website.

### How to Use the Method:

For a user:
1. Register and/or login to the aggregator's website.
2. Review the list of content providers and their content as well as the category in which these are.
3. The pricing is arranged per category and a pricing model.
4. Select the content(s) you would like to subscribe to—many as required.
5. Submit this selection to the website and an estimated pricing is calculated. You will only be charged for content that you access.
6. Provide your credit card or payment info.
7. A periodic fixed charge may be applied to your account.
8. You can now access the provided content.
9. You may now access the content. A usage charge will be applied in accordance with the contents that you access.
10. You may change your selection periodically or at anytime.
11. You may cancel your subscription at anytime, and you will only pay for the content you have consumed.
   For content provider:
1. Register or login at aggregator's website.
2. Provide a list of secure content you want to make available to users.
3. In most embodiments, content is secured content which is not be available to an unregistered user on your website.
4. Indicate how much you wish to be paid for the content and the pricing model, e.g. 1USD per click.
5. Sign a guarantee of the availability of the content online. Note that a penalty will be accessed to your account if the content is unexpectedly unavailable.

The content described herein can be used for newspapers, publishing, video and media.

This method provides a scalable model for both content providers and content consumers. The more content consumers and the more content providers there are, the more the economy of scale—leading to lower subscription cost to consumers, and more profitable returns to content providers. This method will lead to more content providers providing their content online.

Although the invention has been described with reference to embodiments herein, those embodiments do not limit the invention. Modifications to those embodiments or other embodiments may fall within the scope of the invention.

What is claimed is:

1. A method of distributing web content, comprising:
(a) providing a website accessible to web content providers and consumers;
(b) registering at least one content provider via software executing on a computer;
(c) querying the at least one content provider for content via software executing on a computer;
(d) querying the at least one content provider for a desired fee for the content via software executing on a computer;
(e) registering a consumer via software executing on a computer;
(f) displaying a representation of the content and the fee to the consumer on the website via software executing on a computer;
(g) providing the content to the consumer in response to a request from the consumer;
(h) collecting the fee from the consumer via software executing on a computer; and
(i) providing a portion of the fee to the content provider that provided the content.

2. The method of claim 1, wherein step (i) is performed via software executing on a computer.

3. The method of claim 1, further comprising:
(j) querying the consumer for feedback on the content subsequent to step (g).

4. The method of claim 1, further comprising:
(j) providing a portion of the fee collected in step (h) to the provider of the website.

5. The method of claim 1, further comprising:
(j) collecting payment information from the consumer via software executing on a computer prior to step (h).

6. The method of claim 1, further comprising:
(j) collecting account information from the at least one content provider prior to step (i).

7. The method of claim 1, wherein the fee collected in step (h) is collected on a per-click basis.

8. The method of claim 1, wherein the fee collected in step (h) is collected on a periodical basis.

9. The method of claim 1, further comprising:
(j) penalizing a content provider if their content is unavailable.

10. The method of claim 1, further comprising:
(j) collecting a deposit from the consumer prior to step (g).
